(19) United States
(12) Patent Application Publication
(10) Pub. No.: US 2018/0168108 A1
(43) Pub. Date: Jun. 21, 2018

(54) MODULAR PLANT GROWTH SYSTEM

(71) Applicants: Robert Neil H. Foreman, Santa Barbara, CA (US); Theodore K. Bliss, Santa Barbara, CA (US); Ryan Olson, Goleta, CA (US)

(72) Inventors: Robert Neil H. Foreman, Santa Barbara, CA (US); Theodore K. Bliss, Santa Barbara, CA (US); Ryan Olson, Goleta, CA (US)

(21) Appl. No.: 15/382,193

(22) Filed: Dec. 16, 2016

(51) Int. Cl. A01G 9/02; A01G 27/00; A01G 1/00; A01G 7/04; A01G 9/20

(52) U.S. Cl. CPC A01G 9/023; A01G 27/003; A01G 9/20; A01G 7/045; A01G 1/001

(57) ABSTRACT

A growth system based on gravity fed irrigation and collection, integrated illumination suitable for plant growth, and growth pods installable in the system containing seeds or young plants and a growth medium. In some embodiments, the pods may be separate entities preloaded with dormant seeds and growth medium from a provider , and when installed in the system at an angle from vertical, germinate and grow when the system exposes the installed pods to suitable predetermined irrigation and illumination cycles for the particular plant varieties in the pods.

### BACKGROUND

### Field

The disclosure relates generally to plant growth systems suitable for indoor use or use in areas not suitable for garden or field planting.

### Description of Related Art

Growing herbs, vegetables and other non-decorative plants in indoor or other restrictive environments may be desirable for many individuals who do not have access to typical garden or open field plant growth environments, and accordingly they may desire innovative new designs for standalone plant growth systems.

### BACKGROUND

Scattering scanning near field optical microscopy (s-SNOM) operates by interacting a sharp probe tip of a probe microscope with a sample surface and collecting light scattered from the region of tip-sample interaction. Using this technique, it is possible to measure the optical properties of samples with a spatial resolution far below the conventional diffraction limits. The resolution improvement comes from a local enhancement of the incident radiation field due to the sharp tip. The enhanced radiation field interacts with the sample and then scatters radiation into the far field. This near-field enhancement increases the amount of radiation scattered from the tip-sample region such that the scattered radiation can be more easily detected from nanoscale regions of a sample. Atomic force microscope based infrared spectroscopy (AFM-IR) provides chemical characterization and compositional mapping on nanometer length scales by using the tip of an atomic force microscope to locally detect absorption of infrared radiation.

### SUMMARY AND BRIEF DESCRIPTION

Example embodiments described herein have innovative features, no single one of which is indispensable or solely responsible for their desirable attributes. Without limiting the scope of the claims, some of the advantageous features will now be summarized.

In some embodiments, a growth system may be provided based on gravity fed irrigation and collection, integrated illumination suitable for plant growth, and growth pods installable in the system containing seeds or young plants and a growth medium. In some embodiments, the pods may be separate entities preloaded with dormant seeds and growth medium from a provider, and when installed in the system at an angle from vertical, germinate and grow when the system exposes the installed pods to suitable predetermined irrigation and illumination cycles for the particular plant varieties in the pods.

In one embodiment of a first aspect a standalone modular plant growth system may be provided: including at least one removable growth pod with a length to width ratio greater than one, including at least one region transparent to a light source, at least one irrigation inlet aperture, at least one irrigation outlet aperture, and a plant growth matrix: and, a structure, including at least one irrigation source; at least one lighting source; at least one mounting element, configured to accept the removable growth pods; and, at least one irrigation collection element: wherein the structure is configured to accept the growth pods in the mounting element oriented at an angle between 10 and ninety degrees from vertical between the irrigation source and the irrigation collection element, with the transparent region configured to allow the light source to illuminate the growth matrix, the irrigation inlet aperture oriented up toward the irrigation source at a point on the long axis equal to or vertically above at least part of the growth matrix, the irrigation outlet aperture oriented down toward the irrigation collection element and located at least one of adjacent or at the lowest point vertically of the mounted pod.

In one embodiment of the first aspect, the system may further include: a processor; a user interface and display; and, a power supply. In another embodiment of the first aspect the mounting element may be configured to hold two or more pods and, the lighting source may be configured to be in view of the transparent regions and the irrigation source may be configured to line up vertically to gravity feed the irrigation outlets. In one embodiment of the first aspect, the structure may be configured to accept two or more mounting elements stacked vertically, configured to hold the pods in one element staggered horizontally relative to the other mounting element(s) whereby illumination and irrigation of each pod is maintained.

In another embodiment of the first aspect each mounting element may include at least one irrigation source. In another embodiment of the first aspect the mounting element may hold pods staggered around a u-shaped structure, the lighting element may be a corresponding u-shaped source disposed vertically above the pod transparent regions, and the irrigation source may include a u-shaped element configured with irrigation apertures disposed above the pods' irrigation inlet apertures. In one embodiment of the first aspect, the irrigation source may include a primary bay disposed vertically above a fluid delivery system including at least one of a secondary bay or a piping, and the primary bay may be fluidly connected to the delivery system by at least one valve. In another embodiment of the first aspect irrigation access above the pods may be gravity fed by way of through holes in the bottom surface of the delivery system bay and the through hole size and the valve size may be configured to fill the delivery system in a time much less than the time required to drain the delivery system through the holes. In one embodiment of the first aspect, the valve may be a solenoid controlled valve.

In one embodiment of the first aspect, the irrigation collection element may be a bay disposed under the pods and positioned to collect at least one of directly or through a funneling structure the outflow from the pods' outlet apertures. In another embodiment of the first aspect at least one of the primary irrigation source bay or the collection bay may include a fluid level sensor connected to the processor. In another embodiment of the first aspect the fluid level sensors may be floats including at least one of; magnetic floats and the float position is sensed by a hall effect sensor; floats configured to actuate position switches; or floats configured to actuate valves at predetermined positions.

In one embodiment of the first aspect, the lighting system may be controlled by the processor. In one embodiment of the first aspect, the lighting system may be comprised of a plurality of LED's of varying color. In another embodiment of the first aspect the LED's may include soft blue and soft red LED's to create a soft white illumination. In one embodiment of the first aspect, the growth matrix may be at least one of soil, soil plus filler, or soil plus structural particles.

In one embodiment of the first aspect, the system may be configured as a counter-top system for small plants, and the dimensions may be on the order of ½ to 2 feet in length, width and height and the pods cylindrical like shapes may be on the order 2 or more inches long and ranging from ½ to 1 and ½ inches in diameter. In another embodiment of the first aspect the system may be configured as a system for medium to large sized plants and the dimensions may be on the order of 1 to 10 feet in length, width and height, and the pods may be cylindrical like shapes greater than 2 inches long and 1 inch in diameter.

In a second aspect a standalone modular plant growth system may be provided, including: a structure, including a processor; at least one irrigation source comprising a primary bay with a fluid level sensor connected to the processor and a secondary bay, with the primary and secondary bay fluidly connected by a processor controlled valve; at least one lighting source controlled by the processor; at least one mounting element; at least one irrigation collection element including a collection bay with a fluid level sensor connected to the processor; a user interface and display connected to the processor; and a power supply: and, at least one growth pod with a length to width ratio greater than one, including at least one region transparent to the light source, at least one irrigation inlet aperture, at least one irrigation outlet aperture, and a plant growth matrix embedded with seeds; wherein the structure may be configured to hold the growth pods in the mounting element with the long axis of the growth pods at an angle between 10 and ninety degrees from vertical oriented vertically between the irrigation source secondary bay and the collection bay, with the transparent region configured to allow the light source to illuminate the growth matrix, the irrigation inlet aperture oriented up toward the irrigation source at a point on the long axis equal to or vertically above at least part of the growth matrix, the irrigation outlet aperture oriented down toward the irrigation collection element and placed at least one of adjacent or at the lowest point vertically of the mounted pod, the system further configured to: accept instructions on growth scenarios from a user through the user interface to the processor; execute timed sequences of irrigation by opening the valve, and timed sequences of illumination by turning on and off the light source according to at least one of per the instructions or according to preset routines; and monitor the fluid levels in the bays and at least one of communicate information to the users relative to the fluid levels by way of the user interface and display or stop operation of the system if the fluid levels are at unacceptable levels.

In one embodiment of the second aspect, the growth pods with seeds may be maintained in a dormant state until installed in the system and exposed to irrigation and illumination.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 depicts the system elements of an illustrative embodiment.

FIGS. 2A and 2B depict an exemplary embodiment of a growth pod.

FIG. 3 shows an illustrative embodiment of modular mounting elements.

FIG. 4 shows an illustrative embodiment of a level sensor.

FIGS. 5A and 5B show an illustrative embodiment a secondary bay irrigation element.

FIGS. 6A and 6B show an illustrative embodiment of a lighting source.

FIGS. 7A and 7B show alternative illustrative embodiments of irrigation source arrangements.

### DETAILED DESCRIPTION OF ILLUSTRATIVE EMBODIMENTS

Many people worldwide do not have access to open air garden or field space for growing herbs, vegetables, decorative plants or plants in general. Even for those who do have access to such spaces, indoor plant cultivation may still hold appeal for a variety of reasons, such as year-round growing or even for the visual and sensory appeal of growing plants. The current disclosure describes a stand-alone growth system including lighting, irrigation, and growth media centers. The system is modular in the sense that the growth centers are in the form of removable pods, containing the growth media, i.e. soil, amended soil, soil substitutes etc., as well as the plants themselves. In some embodiments the pods may be provided with seeds in a dormant state, which will germinate when the pods are installed in the system and subsequently exposed to light and irrigation. Thus pods of many different plant varieties may be available separately from the system allowing users to use one base system for a variety of plants over time simple by changing out the pods. In some embodiments, the system may have control mechanisms and sensors for the lighting and irrigation controlled by a processor and allowing a user through an interface to program and use lighting and irrigation sequences tailored to specific plants.

One or more embodiments described herein may provide an attractive, versatile indoor plant growth system that is easy to use and maintain.

One or more embodiments described herein may provide a modular, programmable plant growth system, based on interchangeable growth pods, allowing for convenient scaling and selection of the number and type of plants.

### Aspects of a Modular Plant Growth System

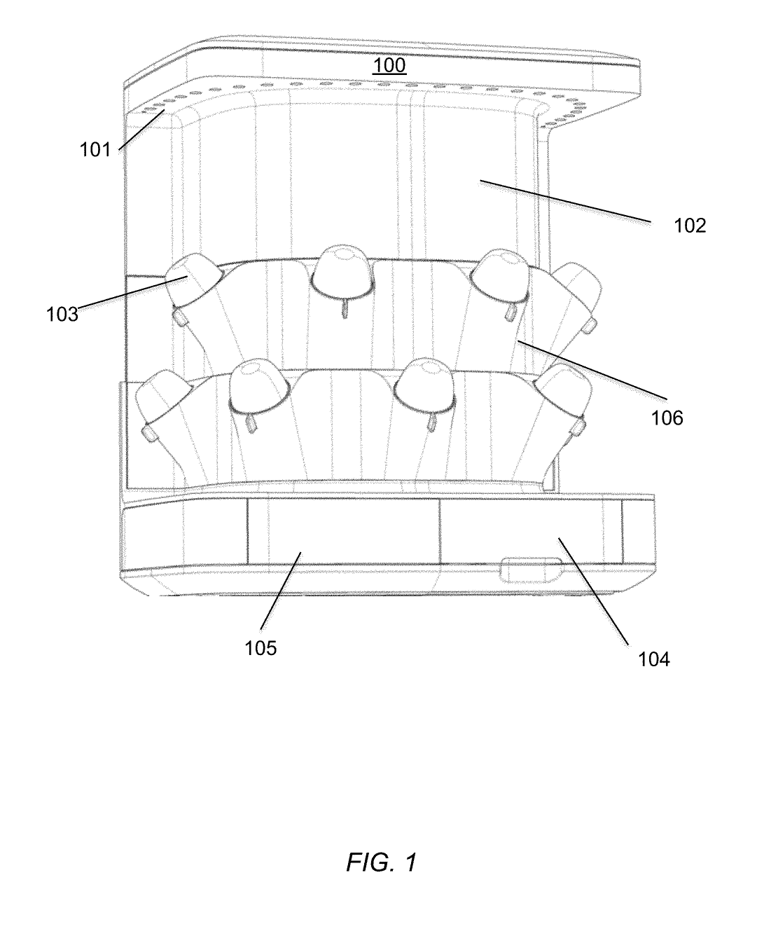

Referring to FIG. 1 the exterior of an exemplary embodiment of a plant growth system 100 is shown. The various elements of the system 100 may be made of a variety of materials, but to keep costs down for consumer use and to facilitate mass production, various formable plastics and rubbers may be advantageous. Such materials suitable for various parts of the system may include polycarbonate, clear poly carbonate, ABS, polypropylene, clear polypropylene, polyurethane, clear polyurethane, TPE, and other rubbers. These materials may be fabricated in the desired shapes and formed together where needed using injection molding thermoforming, and other molten plastic techniques suitable for low cost mass production.

System 101 includes lighting source 101, and irrigation source 102, which may include an irrigation storage bay and an irrigation delivery system, embodiments of which will be disclosed below, and which in the FIG. 1 exemplary are behind an exterior facade, but which could also be exposed to view with a clear facade. The system 100 also may include a mounting element 106, which is configured to accept growth pods 103. Also present is an irrigation collection element or recycle bay 104 to collect run-off from the pods during irrigation cycles, and a user interface, possibly with display 105, shown as a touch screen type interface, but switch and/or knob based user interfaces are also possible.

The system 100 is configured with the lighting and irrigation bay at the top, the pods arranged below the lighting and irrigation source, and the irrigation collection element below the pods, so the system 100 is gravity fed. The pods are longer than they are wide to accommodate both plant and root growth efficiently. They are mounted with their long axis at an angle, at least 10 degrees but less than ninety degrees from vertical, usually between 30 and 60 degrees. This allows for a combination of efficient exposure to the lighting source above, while providing an unfettered growth path avoiding growth straight up toward the lighting source. The pod angle must be less than 90 degrees to support the proper gravity fed irrigation as will be discussed below

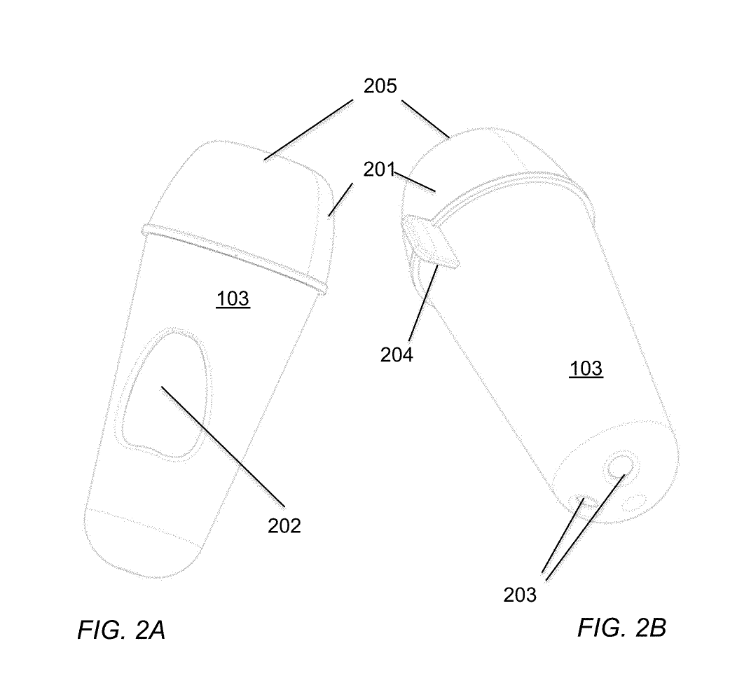

Referring to FIGS. 2A and 2B, an exemplary embodiment of a growth pod is shown. The shape is a rounded, tapered cylinder, with the wide end at the top. Other shapes are possible as long as the shape is longer than it is wide and accommodates the required apertures as will be described below. Inside the pod will be the growth matrix (not shown) and usually the growth matrix will be held away from the very bottom end of the pod by a barrier that holds the matrix but allows for fluid flow such as a fine mesh screen. The growth matrix may be a soil or soil substitute. Possible matrixes include: soil, amended soil, rot resistant purified soil with purified additives, peat moss; soil or soil equivalents with structures such as husks, rockwool, or honeycomb, and others. At least a portion of the pod 103 must be transparent to light, shown as transparent end 201 in the Figure. However any or all of the pod could be transparent as long as the transparent section allows for light to impinge on the matrix and at least part of the growth axis of the plant. With the pod 103 mounted in the system at an angle above horizontal, but less than vertical, various apertures support irrigation, and plant growth. First Irrigation inlet aperture, 202 facing up toward the irrigation source, and arranged so the irrigation fluid falls on or above the growth matrix. For this specific embodiment, aperture 201 will be removed after germination and before plant growth. Initially there is no opening for plant growth as a clear aperture 201 is used to create a warm, humid micro environment to facilitate germination Then irrigation run-off outlet aperture or apertures 203 for draining excess irrigation, and these apertures should be at least below the matrix and preferably at the low point of the pod when the pod is installed. The angular mounting of the pod along with the arrangement of the apertures and transparent portions accomplishes several desirable features as compared to typical vertical growth arrangements. At an angle, the transparent section allows illumination of lower part of the plant and the matrix even after the plant grows out of the pod. The angular mounting aids in smooth flow of the irrigation fluid through the matrix and out of the pod. Finally the angular mounting directs the plant growth away from the pod and away from the lighting and irrigation sources, thus ensuring that neither are impeded as the plant grows. The pods may also include elements for mounting, alignment and retention, not shown or described, as many possible approaches would be suitable.

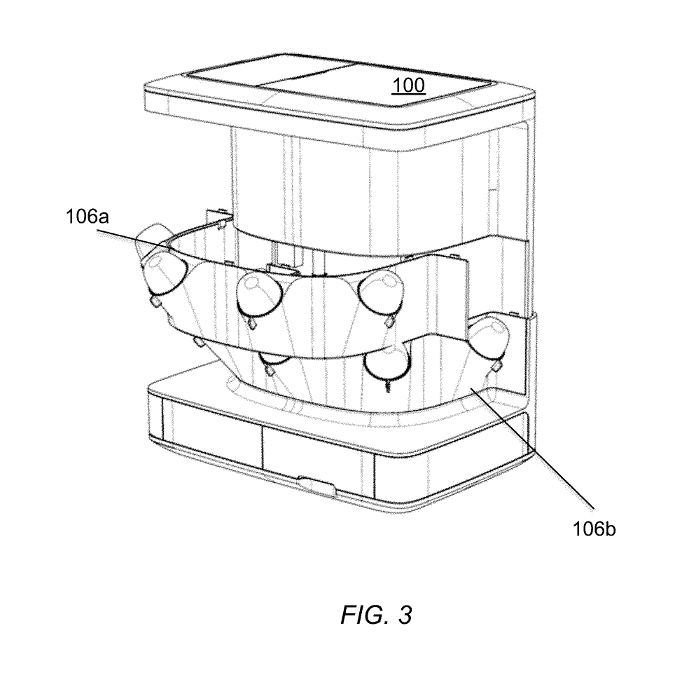

FIG. 3 shows that mounting elements 106 may be modular, as shown in stacked vertical mounting element modules 106a and 106b. Thus the system may be expandable, laterally or vertically, depending on design. For the vertical stacking, around a U-shaped structure, the pod mounting points need be staggered horizontally to allow access to the irrigation source above.

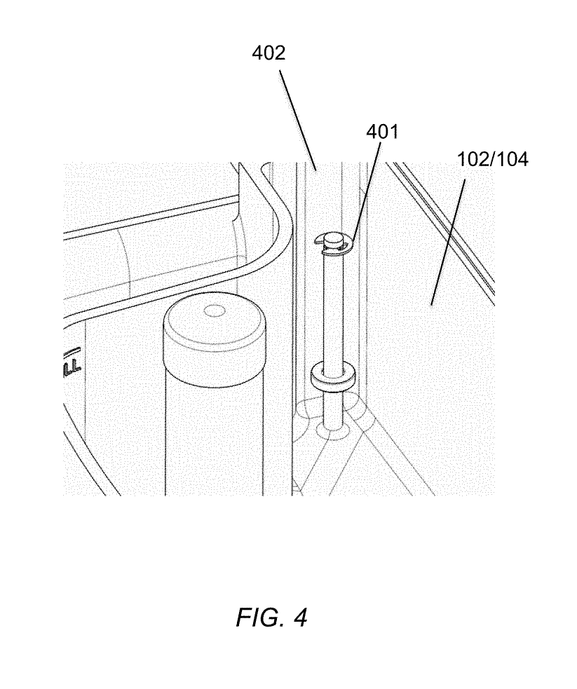

FIG. 4 illustrates the use of fluid level sensors in the irrigation bay 102 and the collection element or bay 104. Shown in the figure is a magnetic float and float guide 401 arranged to float up or down in proximity to a hall effect sensor 402. Other arrangements of floats may also be employed, including arranging a float to trip one or more switches set at desired levels, or even a float actuated mechanical structure, such as uses in toilet bowls. Both the irrigation source and collection levels provide useful information for the operation of the system. For instance if the collection bay is full, at the very least the user should be warned and it may also be advantageous to turn off the irrigation source. Similarly if the source bay is low, both a warning and/or a shut down may be desirable. Any or all of these actions could be accomplished with floats actuating mechanical, electrical, or magnetic devices, depending on the design of the system.

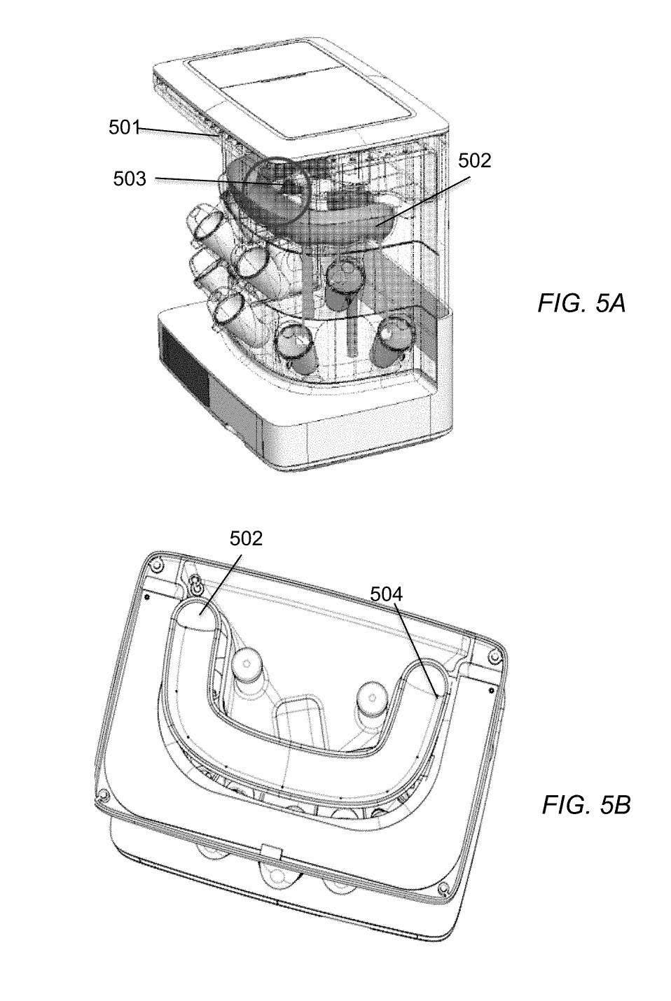

FIGS. 5A and 5B illustrate an irrigation delivery system embodiment. In this embodiment, the irrigation source includes several elements. First the source bay 501 is a reservoir, a primary bay so to speak, which can be filled by the user with a fluid which will usually be growth agents (nutrients, etc) mixed with water or water alone. A delivery system 502 is disposed below the primary bay 501 between the primary bay 501 and the pods. Between the primary bay and the delivery system is a valve 503, which may be an electrically controllable valve such as solenoid valve, or a mechanically controlled valve. In the particular embodiments of FIGS. 5A and 5B, the delivery system 502 is a secondary bay, arranged with through hole irrigation ports 504 above the inlet aperture of each growth pod. The valve is configured to present a much larger aperture when open than the through hole size, such that when the valve is opened, the secondary bay fills at or faster then the drain time of all the through holes. This arrangement allows for single valve operation, as opposed to the possible but less efficient approach of irrigating each pod under independent valve control. The U-shaped structure and corresponding U shaped secondary bay as shown in the Figures is by way of example only and other arrangements, i.e. linear, circular, wedge shaped and other could be operated essentially the same way as the U-shaped configuration.

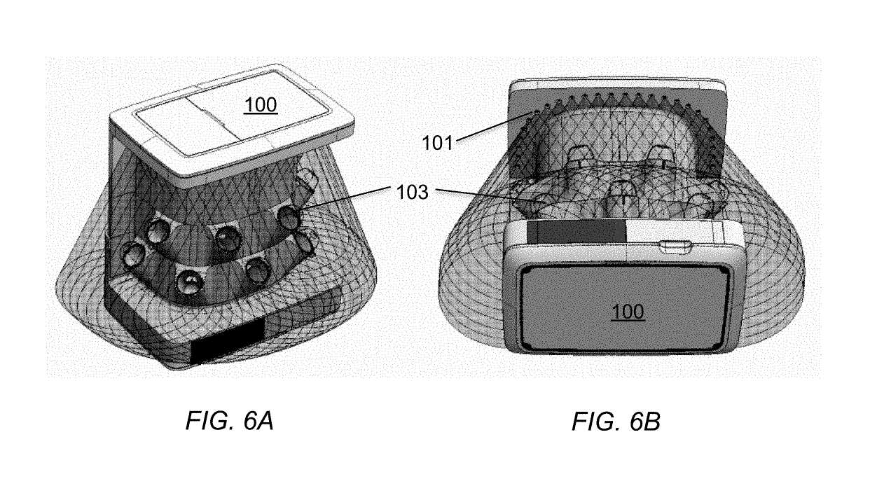

FIGS. 6A and 6B show an illustrative lighting source embodiment for the U-shaped configuration. In this embodiment, light source 101 is an LED array arranged to illuminate the transparent areas of pods 103. Other light sources, such as fluorescent, gro-lights and others could be employed. LED's could be chosen from a wide variety of visible and UV wavelengths and the array could be composed of LED's of different wavelengths to achieve a desired mix.

System 100 could be operated in a variety of ways, including electrical timers, mechanical timers, electrically operating valves, mechanical valves, electrical sensors, magnetic sensors and mechanical level actuators, in any combination. One particularly effective way to configure the system is to use programmable processing or logic, with all of the components under programmable control. Thus the irrigation source valve would be processor actuated, the lighting source would be under processor control, sensors would interface to the processor, and there would be display and user interface elements between the processor and the user. Thus the user could either select pre-planned and/or custom irrigation/lighting sequences through the user interface and the processor could execute those sequences automatically. Thus the lighting/irrigation sequences could be appropriate the particular plants in the pods at any time and new plants in new pods could easily be accommodated. The processor could also monitor the level sensors and alert the user when they are too low or full and/or stop operation of the system until the levels are proper.

The embodiments shown and discussed assume that the filling of the irrigation source and the emptying of the collection bay would be manual operations. However other scenarios are possible. The source bay could be hooked up to a water supply and a nutrient supply and under valve control the bay could be automatically filled when needed. The collection bay could either include a pump to deliver excess back to the irrigation bay and/or be connected to a drain. Any and all arrangements for fill and drain functions may be suitable to the key operational elements of the system.

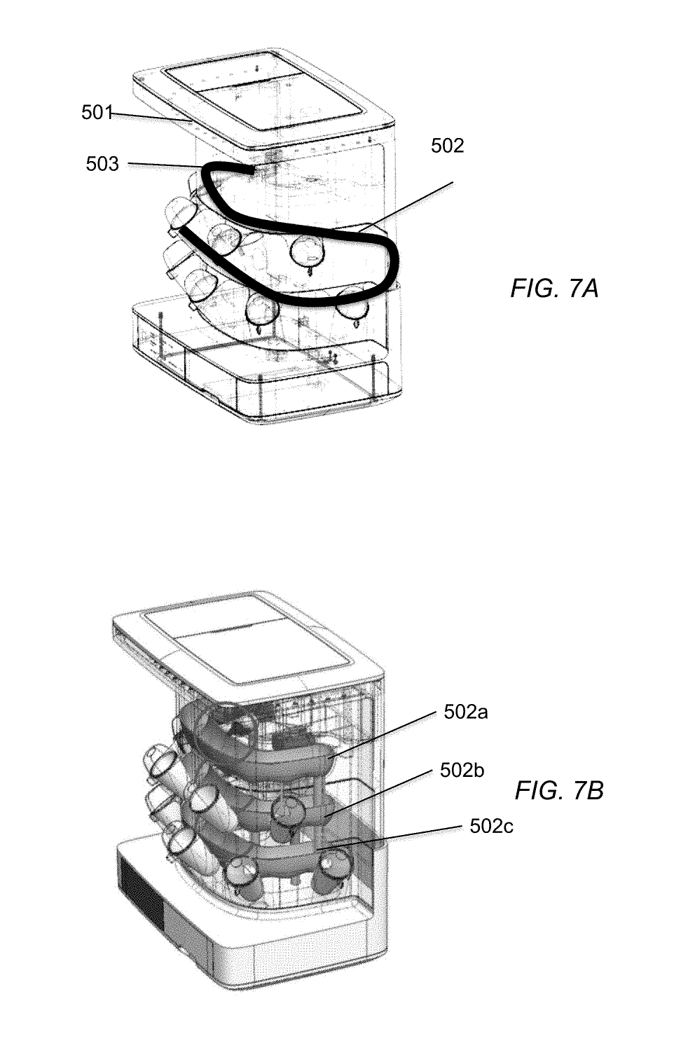

FIGS. 7A and 7B show alternative delivery systems. In FIG. 7A, rather than use a secondary bay with through holes, a gravity fed piping arrangement 503 that in a descending manner passes over each growth pod. The pipe could have a small hole, compared to the valve aperture, at each growth pod position. In this arrangement, the valve 503 could just stay open for a suitable length of time if the pipe doesn't hold enough fluid for an irrigation cycle. In FIG. 7B for the case where multiple pod mounting elements are used, each mounting section could have its own delivery system 502a, 502b, 502c etc, for as many modules as are employed. Both the secondary bay and delivery piping approach as well as other delivery systems arrangements could be used in this manner. The primary bay could address the multiple delivery systems in a variety of ways. For the case of secondary bays, each bay could have a lowered lip section above the bay below and the valve could be left open long enough to fill both (or all bays). Also multi-position valves with piping attachments could be employed.

### Example Embodiment of a Modular Plant Growth System

The following describes an example of plant growth system, for small plants such as herbs or flowers. A U-shaped configuration 14′ long, by 6″ deep and 20″ high, mounts 8 pods on two levels. The pods are tapered, rounded cylinders 1.8″ diameter by 3.2″ long, made of polypropylene and clear polypropylene. The arrangement is a primary bay at the top of ˜0.8 cubic meter volume and the secondary bay is ˜1.4 cubic meters. The solenoid valve to through hole size ratio was set such that all 8 through holes were ˜90% of the fill aperture size. The lighting system is a U-shaped LED array arranged to cover the bottom of a U-shaped lip at the top of the system in view of the transparent part of the pods, composed of a mixture of soft red and soft blue LED's, to create a soft white visual appearance. The system utilizes a processor interfaced to the LED power, the solenoid valve and two hall effect level sensors in the irrigation and collection bays. Fill and emptying of bays is manual. A dead front touch screen display is the user interface/display. The system is programmed to stop operation and display an alert when either the irrigation bay is below a certain level or the collection bay is above a certain level. At typical irrigation levels, the primary bay holds enough for ˜100 days of operation, and the collection bay typically does not fill before the irrigation bay goes empty. The user may either program in their own irrigation/lighting cycles, or a series of pre-planned cycles suitable for flowers, vegetables, greens, or herbs are available.

### Scalability of the Modular Plant Growth System

The above example is small scale, counter top system on the order of <2, in the longest direction. However both the system and pod configurations disclosed scale up readily for larger plants or larger spaces. For instance a table top system may have dimensions on the order of 5′ plus or minus and floor/wall mount systems could be as large as 10′ or more. Pod size also scales accordingly depending on plant type. Larger systems could accommodate pods of multiple sizes allowing a range of plant types in one system. Also the embodiments discussed herein were of a freestanding arrangement, but wall mount or other support structures are possible

The embodiments described herein are exemplary. Modifications, rearrangements, substitute processes, alternative elements, etc. may be made to these embodiments and still be encompassed within the teachings set forth herein. One or more of the steps, processes, or methods described herein may be carried out by one or more processing and/or digital devices, suitably programmed.

Depending on the embodiment, certain acts, events, or functions of any of the method steps described herein can be performed in a different sequence, can be added, merged, or left out altogether (e.g., not all described acts or events are necessary for the practice of the algorithm). Moreover, in certain embodiments, acts or events can be performed concurrently, rather than sequentially.

The various illustrative control elements described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processor configured with specific instructions, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. A software module can comprise computer-executable instructions which cause a hardware processor to execute the computer-executable instructions.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices or methods illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A standalone modular plant growth system, comprising:
at least one removable growth pod with a length to width ratio greater than one, comprising at least one region transparent to a light source, at least one irrigation inlet aperture, at least one irrigation outlet aperture, and a plant growth matrix; and, a structure, comprising
at least one irrigation source;
at least one lighting source;
at least one mounting element, configured to accept the removable growth pods; and,
at least one irrigation collection element:
wherein the structure is configured to accept the growth pods in the mounting element oriented at an angle between 10 and ninety degrees from vertical between the irrigation source and the irrigation collection element, with the transparent region configured to allow the light source to illuminate the growth matrix, the irrigation inlet aperture oriented up toward the irrigation source at a point on the long axis equal to or vertically above at least part of the growth matrix, the irrigation outlet aperture oriented down toward the irrigation collection element and located at least one of adjacent or at the lowest point vertically of the mounted pod.

2. The system of claim 1 further comprising:
a processor;
a user interface and display; and,
a power supply.

3. The system of claim 1, wherein the mounting element is configured to hold two or more pods and, the lighting source is configured to be in view of the transparent regions and the irrigation source is configured to line up vertically to gravity feed the irrigation outlets.

4. The system of claim 3, wherein the structure is configured to accept two or more mounting elements stacked vertically, configured to hold the pods in one element staggered horizontally relative to the other mounting element(s) whereby illumination and irrigation of each pod is maintained.

5. The system of claim 4 wherein each mounting element includes at least one irrigation source.

6. The system of claim 3 wherein the mounting element holds pods staggered around a u-shaped structure, the lighting element is a corresponding u-shaped source disposed vertically above the pod transparent regions, and the irrigation source includes a u-shaped element configured with irrigation apertures disposed above the pods' irrigation inlet apertures.

7. The system of claim 1 wherein the irrigation source comprises a primary bay disposed vertically above a fluid delivery system including at least one of a secondary bay or a piping, and the primary bay is fluidly connected to the delivery system by at least one valve.

8. The system of claim 7 wherein irrigation access above the pods is gravity fed by way of through holes in the bottom surface of the delivery system bay and the through hole size and the valve size are configured to fill the delivery system in a time less than the time required to drain the delivery system through the holes.

9. The system of claim 7 the wherein valve is a solenoid controlled valve.

10. The system of claim 7 wherein the irrigation collection element is a bay disposed under the pods and positioned to collect at least one of directly or through a funneling structure the outflow from the pods' outlet apertures.

11. The system of claim 10, wherein at least one of the primary irrigation source bay or the collection bay includes a fluid level sensor connected to the processor.

12. The system of claim 11 wherein the fluid level sensors are floats including at least one of;
magnetic floats and the float position is sensed by a hall effect sensor;
floats configured to actuate position switches; or
floats configured to actuate valves at predetermined positions.

13. The system of claim 2 wherein the lighting system is controlled by the processor.

14. The System of claim 1 wherein the lighting system is comprised of a plurality of LED's of varying color

15. The system of claim 14 wherein the LED's include soft blue and soft red LED's to create a soft white illumination.

16. The system of claim 1 wherein the growth matrix is at least one of soil, soil plus filler, or soil plus structural particles.

17. The system of claim 1 wherein the system is configured as a counter-top system for small plants, and the dimensions are on the order of ½ to 2 feet in length, width and height and the pods cylindrical like shapes are on the order 2 or more inches long and ranging from ½ to 1 and ½ inches in diameter.

18. The system of claim 1 wherein the system is configured as a system for medium to large sized plants and the dimensions are on the order of 1 to 10 feet in length, width and height, and the pods are cylindrical like shapes greater than 2 inches long and 1 inch in diameter.

19. A standalone modular plant growth system, comprising:
a freestanding structure, comprising
a processor;
at least one irrigation source comprising a primary bay with a fluid level sensor connected to the processor and a secondary bay, with the primary and secondary bay fluidly connected by a processor controlled valve;
at least one lighting source controlled by the processor;
at least one mounting element;
at least one irrigation collection element comprising a collection bay with a fluid level sensor connected to the processor ;
a user interface and display connected to the processor; and,
a power supply; and,
at least one growth pod with a length to width ratio greater than one, comprising at least one region transparent to the light source, at least one irrigation inlet aperture, at least one irrigation outlet aperture, and a plant growth matrix embedded with seeds; wherein
the structure is configured to hold the growth pods in the mounting element with the long axis of the growth pods at an angle between 10 and ninety degrees from vertical oriented vertically between the irrigation source secondary bay and the collection bay, with the transparent region configured to allow the light source to illuminate the growth matrix, the irrigation inlet aperture oriented up toward the irrigation source at a point on the long axis equal to or vertically above at least part of the growth matrix, the irrigation outlet aperture oriented down toward the irrigation collection element and placed at least one of adjacent or at the lowest point vertically of the mounted pod, the system further configured to;
accept instructions on growth scenarios from a user through the user interface to the processor;
execute timed sequences of irrigation by opening the valve, and timed sequences of illumination by turning on and off the light source according to at least one of per the instructions or according to preset routines; and,
monitor the fluid levels in the bays and at least one of communicate information to the users relative to the fluid levels by way of the user interface and display or stop operation of the system if the fluid levels are at unacceptable levels.

20. The system of claim 19 wherein the growth pods with seeds are maintained in a dormant state until installed in the system and exposed to irrigation and illumination
